(19) United States
(12) Patent Application Publication
(10) Pub. No.: US 2013/0147983 A1
(43) Pub. Date: Jun. 13, 2013

(54) APPARATUS AND METHOD FOR PROVIDING LOCATION INFORMATION

(71) Applicant: SL CORPORATION, Daegu (KR)

(72) Inventor: Sun Kyoung Park, Gyeongsan (KR)

(73) Assignee: SL CORPORATION, Daegu (KR)

(21) Appl. No.: 13/690,852

(22) Filed: Nov. 30, 2012

(30) Foreign Application Priority Data
Dec. 9, 2011 (KR) 10-2011-0132074

(51) Int. Cl. G06K 9/78

(52) U.S. Cl. CPC G06K 9/78
USPC 348/222.1

(57) ABSTRACT

Provided herein are an apparatus and a method for providing location information, which may determine the location of an object by identifying an overlaid area of the object in a virtual area divided into a plurality of areas when the object is recognized in a photographed image. The apparatus includes a camera configured to generate an image including a photographed object, an area extraction unit, executed by a processor, configured to extract divisional areas corresponding to the photographed object, among a plurality of divisional areas formed by dividing the image, and an output unit, executed by the processor, configured to output the extracted divisional areas.

### CROSS-REFERENCE TO RELATED APPLICATIONS

This application claims priority under 35 U.S.C. §109 from Korean patent Application No. 10-2011-0132074 filed on Dec. 9, 2011, the disclosure of which is incorporated herein in its entirety by reference.

### BACKGROUND OF THE INVENTION

1. Field of the Invention

The present invention relates to an apparatus and a method for providing location information, and more particularly, to an apparatus and a method for providing location information, which can determine the location of an object by identifying an overlaid area of the object in a virtual area, divided into a plurality of areas, when the object is recognized in a photographed image.

2. Description of the Related Art

Recent technological developments provide various methods of creating a wide variety of digital images. In particular, along with widespread use of personal computers and a transition from analog cameras to digital cameras, there has been a recent increase in users capturing digital still images. In addition, the emergence of camcorders allows users to create digital motion images. Moreover since useful functions of the digital cameras and camcorders are also employed on cellular phones, the number of users who obtain digital motion images is further increasing.

A camera module generally includes a lens and an image sensor. Furthermore, the lens collects the light reflected from an object, and the image sensor senses the light collected by the lens and converts the sensed light into an electrical image signal. The image sensor includes a camera tube and a solid-state image sensor. Examples of the solid-state image sensor may include a charge coupled device (CCD) and a metal oxide silicon (MOS).

Meanwhile, often an object or an animal abruptly enters a vehicle lane while the vehicle is traveling and the probability of damages caused to a driver of the vehicle and the object is increasing. To avoid the probable damages, front object sensing techniques based on image processing have been proposed. To sense an object and to determine the location of the object, it may be necessary to employ a high-performance processor. However, in some cases, the image processing may have to be performed using a low-performance processor due to cost efficiency.

Accordingly, there exists a need for systems capable of effectively performing image processing to determine location of an object with improved accuracy while rapidly performing image processing using a low-performance processor.

### SUMMARY OF THE INVENTION

The present invention provides an apparatus and method for providing location information, which can determine the location of an object by identifying an overlaid area of the object in a virtual area, divided into a plurality of areas, when the object is recognized in a photographed image.

The above and other objects of the present invention will become more apparent to one of ordinary skill in the art to which the present invention pertains by referencing the following description of the preferred embodiments.

According to an aspect of the present invention, an apparatus for providing location information is disclosed. The apparatus includes: a camera generating an image including a photographed object and a processor configured to: extract divisional areas corresponding to the object, among a plurality of divisional areas formed by dividing the image; and an output unit and output the extracted divisional areas.

According to another aspect of the present invention, a method for providing location information is disclosed, the method including: generating an image including a photographed object using a camera; extracting divisional areas corresponding to the object, among a plurality of divisional areas formed by dividing the image; and outputting the extracted divisional areas.

As described above, in the apparatus and method for providing location information according to the present invention, the location of an object may be determined by identifying an overlaid area of the object in a virtual area divided into a plurality of areas when the object is recognized in a photographed image, thereby identifying relative location of the object with improved accuracy using an image processing algorithm.

### BRIEF DESCRIPTION OF THE DRAWINGS

The above and other features, objects and advantages of the present invention will now be more clearly understood from the following detailed description taken in conjunction with the accompanying drawings in which:

FIG. 1 is an exemplary block diagram of an apparatus for providing location information according to an exemplary embodiment of the present invention;

FIG. 2 illustrates an exemplary view of an object contained in a photographed image according to an exemplary embodiment of the present invention;

FIG. 3 illustrates exemplary horizontally divisional areas formed by dividing a virtual plate according to an exemplary embodiment of the present invention in a horizontal direction;

FIG. 4 illustrates exemplary vertically divisional areas formed by dividing a virtual plate according to an exemplary embodiment of the present invention in a vertical direction;

FIG. 5 illustrates exemplary lattice divisional areas formed by dividing a virtual plate according to an exemplary embodiment of the present invention in horizontal and vertical directions;

FIG. 6 illustrates an exemplary view of a target object overlaid on a portion of the vertically divisional areas shown in FIG. 4, according to an exemplary embodiment of the present invention;

FIG. 7 illustrates an exemplary view of a target object overlaid on a portion of the horizontally divisional areas shown in FIG. 3, according to an exemplary embodiment of the present invention;

FIG. 8 illustrates an exemplary view of a target object overlaid on a portion of the lattice divisional areas shown in FIG. 5, according to an exemplary embodiment of the present invention;

FIG. 9 illustrates an exemplary view of a distance between one of the lattice divisional areas, on which the target object is overlaid in FIG. 8, and a vanishing point, according to an exemplary embodiment of the present invention;

FIG. 10 illustrates an exemplary view of sizes of horizontally divisional areas varying according to the distance from a particular point according to an exemplary embodiment of the present invention;

FIG. 11 illustrates an exemplary view of sizes of vertically divisional areas varying according to the distance from a particular point according to an exemplary embodiment of the present invention; and

FIG. 12 illustrates an exemplary view of shapes and sizes of lattice divisional areas varying according to the distance from a particular point according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

Hereinafter, the present invention will be described in further detail with reference to the accompanying drawings.

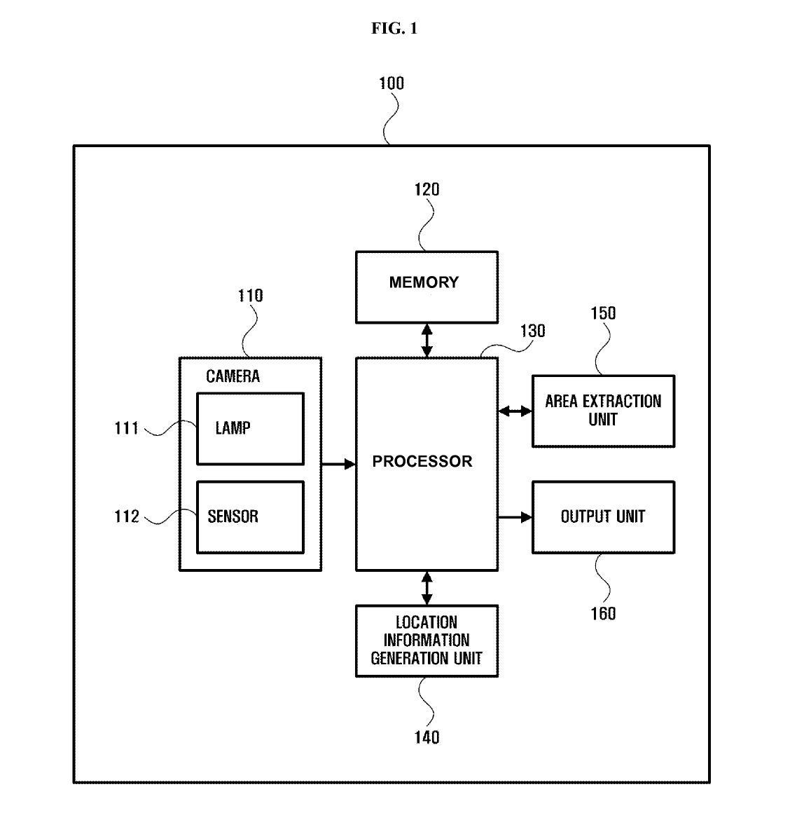

FIG. 1 is an exemplary block diagram of an apparatus for providing location information according to an exemplary embodiment of the present invention. The location information providing apparatus 100 according to an embodiment of the present invention includes a camera 110 and a plurality of units. These units are all embodied on a controller which includes a processor 130 with a memory 120. The units include a location information generation unit 140, an area extraction unit 150 and an output unit 160.

Safe driving for a driver of a vehicle includes watching a direction of travel and paying attention to various external factors. Nevertheless, it may be difficult for the driver to avoid an abruptly appearing external object. For example, when a vehicle is traveling at a low speed or an object appears in front of the vehicle substantially far away, it may be possible to ensure enough time for the driver to recognize the object and avoid a possible collision. However, when a vehicle is traveling at a high speed or an object suddenly appears in front of the vehicle, it may not be possible for the driver to react to the situation.

Moreover, when the vehicle travels at night, there may be an increasing probability of an object suddenly appearing without the driver having enough time to react. In other words, it may be difficult to ensure a driver's view at night even when the vehicle is traveling on a road with street lamps, compared to when the vehicle is traveling in the daytime. In addition, when the vehicle is traveling on a road without a street lamp, a head lamp of the vehicle may provide the main illumination of the road for a driver. Thus, when the driver has sufficient time to avoid the object, the driver may still not recognize the object in front of the vehicle due to poor lighting. In particular, when the vehicle travels on a motorway or a suburban road, the vehicle may be traveling at a high speed, decreasing the likelihood that the driver may recognize the object, thereby increasing the probability of damages caused to the driver and the object or animal. To prevent potential damages, a camera may be installed in front of the vehicle and an image acquired by the camera may be processed. In other words, the driver may be warned of a probable accident or the traveling of the vehicle may be controlled based on the image processing result.

In techniques of detecting an object using image processing, various algorithms, including edge detection, pattern recognition or movement recognition, may be used. In addition, the image processing algorithms may enable rough differentiation of a human, an animal, an object and a picture.

The present invention aims to identify the location of an object. The target object of the present invention includes a living object, for example, a human or an animal, using the image processing algorithm.

The object that may suddenly appear in front of the vehicle may include a pedestrian and an animal. The object that may appear on the traveling route may include other vehicles, which is, however, not taken into consideration in the present invention. However, the target object of the present invention may also include a non-living object (e.g., an automobile or a tree) or a picture (e.g., the central line or traveling lane) according to the manufacture or user's option.

Moreover, since pedestrians and animals may behave differently, ways of avoiding potential collisions may be dealt with differently. For example, there may be a difference between the manners in which the pedestrian and the animal move or appear on a traveling path, and also how the pedestrian and the animal may sense an oncoming vehicle on the traveling path and responding accordingly. Therefore, in consideration of the different behavior patterns of the pedestrian and the animal, it may be desirable to warn the driver of the appearance of the object or to control traveling of the vehicle. Furthermore, it may be necessary to determine whether the object in front of a vehicle is a pedestrian or an animal and to ensure location information, such as a distance between the object and the vehicle.

However, it may be difficult to determine whether the front object is a pedestrian or an animal or to identify location information based solely on the image acquired by the camera. When the front image is acquired from a vehicle traveling at high speed, it may be difficult to recognize the shape of the object due to vibration of the vehicle. Moreover, when the vehicle is traveling at night, it may be more difficult to ensure the information due to poor illumination of the road. In addition, when the shape of the object may be recognized by image processing and object recognition techniques, the type of the object may be determined and the location information of the object may be identified. However, employing such techniques to vehicles may lead to an increase of production costs.

The present invention aims to ensure the location information of an object through image processing, which will later be described in more detail. However, since determining the kind of the object departs from the spirit and scope of the present invention, detailed descriptions thereof will be omitted.

A processor performing image processing may operate at high speed to ensure sufficient time for a driver to respond to the abruptly appearing object. When the processing speed of the processor is low, an error may be generated in recognizing the object or a time required for warning the driver of the object may be delayed. However, as described above, a high-performance processor may result in an increase of the manufacturing costs.

According to the present invention, an image of an object in front of the vehicle is divided into a plurality of divisional areas, and areas corresponding to a target object may be identified among the divisional areas, thereby determining location information of the object. In other words, a target object may be selected among a plurality of objects included in the image, and a distance from the selected target object may be determined without using a separate sensor such as an ultrasonic sensor. In particular, the distance from the selected target object may be determined by dividing a virtual screen area (hereinafter, a virtual plate) into a plurality of divisional areas, overlaying the virtual plate on the image and then identifying divisional areas among the plurality of divisional areas on which the target object is overlaid, or by dividing the image and identifying the divisional areas on which the target object is overlaid.

The camera 110 may generate an image including a photographed object taken in a particular direction. Furthermore, the camera 110 may include a lamp 111 and a sensor 112. The lamp 111 may irradiate a beam into the object. In other words, the lamp 111 may irradiate the beam in a forward direction to identify the object even at night or in dark lighting. A head lamp of a vehicle may serve as the lamp 111, or a separate means may be provided as the lamp 111.

The sensor 112 may receive the beam reflected off of the object and may generate a digital image corresponding to the object. In other words, the sensor 112 receives an analog image signal. Furthermore, the sensor 112 may include a pickup device, and examples of the pickup device may include a charge coupled device (CCD) and a metal oxide silicon (MOS). The sensor 112 may control the gain of the received image signal and may amplify the received image signal by a predetermined amount to facilitate image processing in a subsequent process. In addition, the sensor 112 may include a separate conversion unit (not shown) to convert the amplified analog image signal into a digital image.

In one embodiment, to improve front object recognition efficiency at night, in the location information providing apparatus 100, the sensor 112 may include a sensor for receiving an infrared ray (hereinafter, an infrared ray sensor, hereinafter). In addition, to improve efficiency of the infrared ray sensor, the lamp 111 may irradiate infrared ray beams. Accordingly, the infrared ray sensed by the infrared ray sensor may be a near infrared ray reflected by the object such as a pedestrian or an animal. Moreover, the lamp 111 and the sensor 112 may be incorporated as a single module or may be configured as separate modules. For example, lamps may be provided around the lens of the sensor 112, thereby incorporating the lamp 111 and the sensor 112. Alternatively, the lamp 111 and the sensor 112 may be disposed at different locations. Additionally, one or more lamps 111 and one or more sensors 112 may be provided.

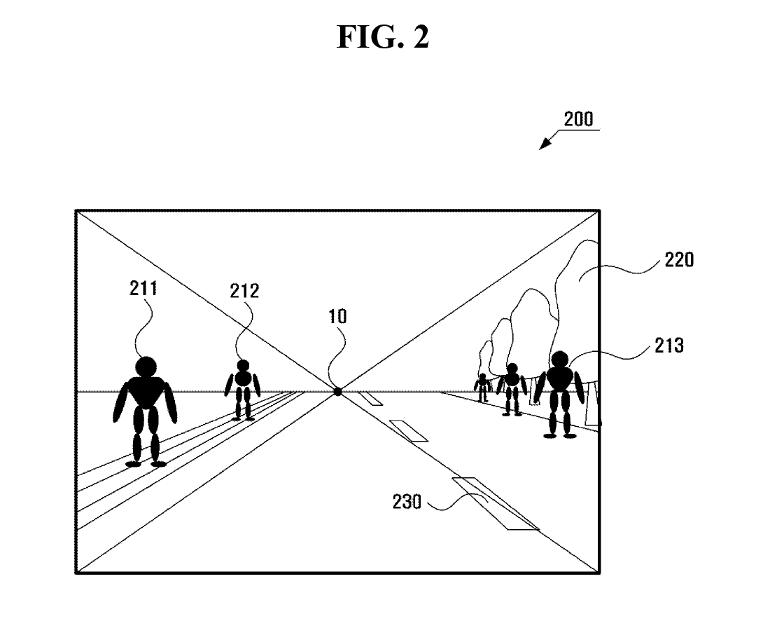

FIG. 2 illustrates an exemplary view of an object contained in a photographed image according to an exemplary embodiment of the present invention.

A digital image 200 generated by the camera 110 may include a variety of objects 211, 212, 213, 220 and 230. The objects may include living objects, such as humans 211, 212 and 213, a non-living object, such as a tree 220, and a picture, such as a traveling lane 230. The main object targeted to ensure the location information thereof may include a living object, such as a human or an animal, but not limited thereto.

Moreover, since the digital image 200 generated by the camera 110 may include two-dimensional information, types of the respective objects 211, 212, 213, 220 and 230 may be determined, however it may be difficult to determine the distance from each of the objects 211, 212, 213, 220 and 230.

Furthermore, the location information providing apparatus 100 according to the embodiment of the present invention may determine the distance from a target object by dividing the virtual plate and identifying divisional areas among the resulting divisional areas, on which the target object is overlaid, or by dividing the image 200 into a plurality of divisional areas and identifying areas among the divisional areas, on which the target object is located. It may be understood that a distance between the vanishing point 10 and the target object in the image 200 may be used in determining the distance from the target object. In other words, determining the distance from the object may be based on the principle that as the distance from the vanishing point 10 decreases, the object becomes farther from a viewer, and as the distance from the vanishing point 10 increases, the object becomes closer to a viewer.

Referring again to FIG. 2, the processor 130 may divide the image 200 into a plurality of divisional areas. In addition, the processor 130 may perform the overall control operations of the camera 110, the memory 120, the location information generation unit 140, the area extraction unit 150 and the output unit 160 and may relay data transmission between various modules.

As described above, according to the present invention, dividing the image into the plurality of divisional areas may be performed by two methods. One method includes dividing the image received from the camera 110, and the other method includes providing a division line for dividing the image and mapping the division line to the image received from the camera 110, instead of dividing the image. It may be understood that mapping of the division line to the image corresponds to using the virtual plate. In either method, it may be possible to identify areas among the divisional areas, on which a particular portion of an image is overlaid. The dividing of the image may be performed by one of the two methods or a combination of the two methods. The following description will focus on the method of mapping the division line, that is, the method of using the virtual plate.

The divisional areas divided by the processor 130 may include at least one of horizontally divisional areas formed by dividing the virtual plate in a horizontal direction, vertically divisional areas formed by dividing the virtual plate in a vertical direction, and lattice divisional areas formed by dividing the virtual plate in horizontal and vertical directions. Furthermore, as described above, the divisional areas divided by the processor 130 may include at least one of horizontally divisional areas formed by dividing the image 200 in a horizontal direction, vertically divisional areas formed by dividing the image 200 in a vertical direction, and lattice divisional areas formed by dividing the image 200 in horizontal and vertical directions.

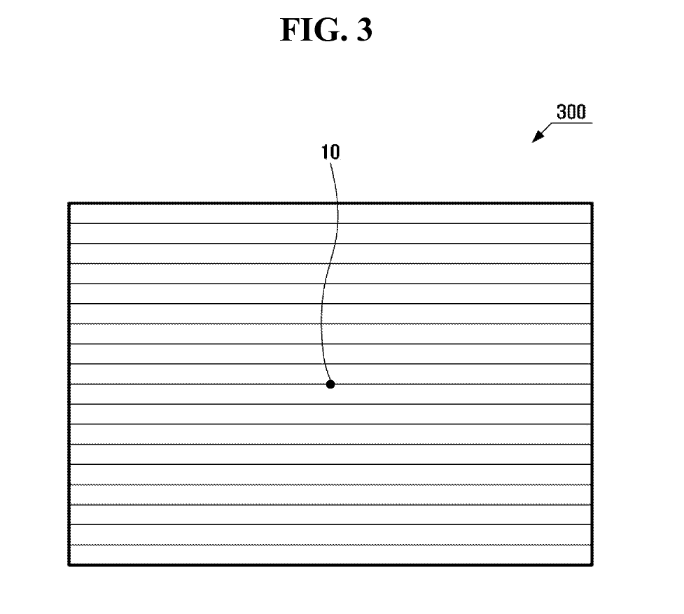

FIGS. 3 to 5 illustrate an exemplary virtual plate 300 including horizontally divisional areas, a virtual plate 400 including vertically divisional areas, and a virtual plate 500 including lattice divisional areas.

As described above, the distance between the viewer and the object may be determined using the distance from the vanishing point 10. Referring to the horizontally divisional areas shown in FIG. 3, the distance between a viewer and the object may be determined using a vertical distance between each of the horizontally divisional areas and the vanishing point 10. In other words, the object included in the horizontally divisional area near the vanishing point 10 is farther from the viewer than the object included in the horizontally divisional area.

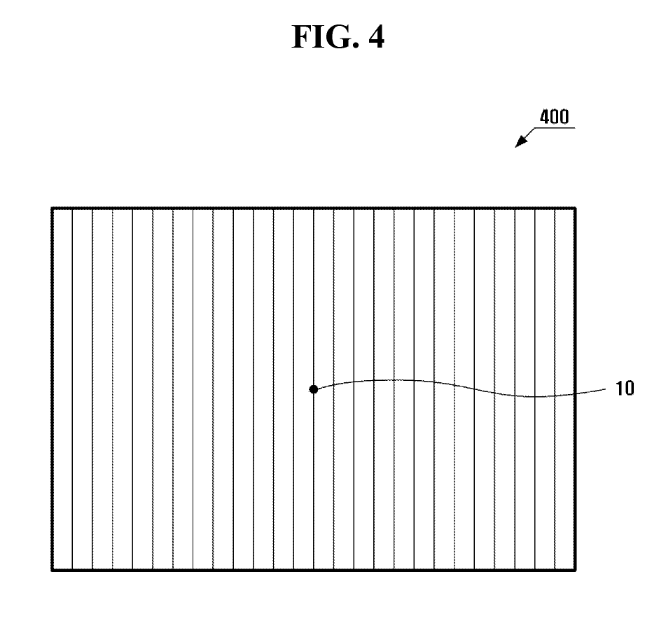

On the other hand, referring to the vertically divisional areas shown in FIG. 4, the distance between the viewer and the object may be determined using a horizontal distance between each of the vertically divisional areas and the vanishing point 10. In other words, the object included in the vertically divisional area near to the vanishing point 10 is farther from the viewer than the object included in the vertically divisional area.

It may be difficult to determine a distance from the object using the horizontally divisional areas or the vertically divisional areas. For example, when an object is included in particular horizontally divisional areas, the distance between the object and the viewer varies according to the horizontal distance between the object and the vanishing point 10. Likewise, when an object is included in particular vertically divisional areas, the distance between the object and the viewer varies according to the vertical distance between the object and the vanishing point 10. Therefore, when the virtual plate is divided by the processor 130 into horizontally divisional areas and the vertically divisional areas, it may be desirable to determine whether the object is included in particular areas using both of the horizontally divisional areas and the vertically divisional areas.

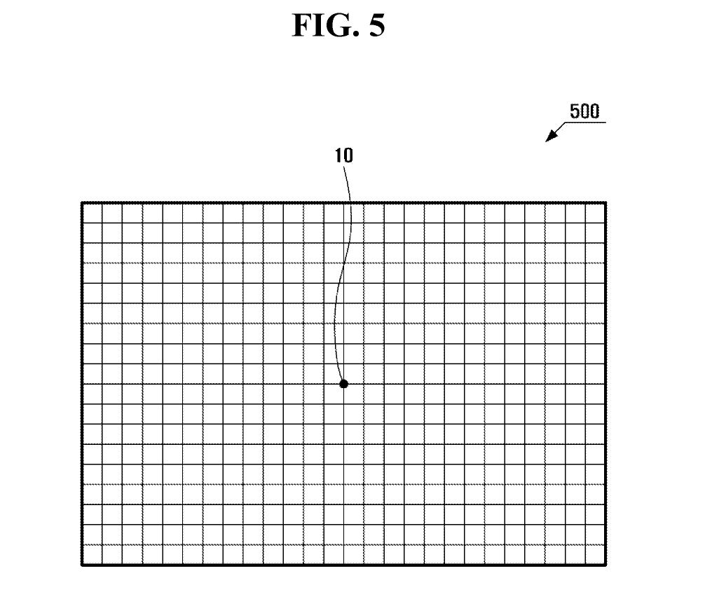

Meanwhile, referring to the lattice divisional areas shown in FIG. 5, the distance between the viewer and the object may be determined using a linear distance between each of the lattice divisional areas and the vanishing point 10. When the virtual plate is divided by the processor 130 into the lattice divisional areas, the distance between the viewer and the object may be determined using the lattice divisional areas.

In practice, it may be understood that the information for determining the distance between the viewer and the object using both of the horizontally divisional areas and the vertically divisional areas may be the same as the information for determining the distance between the viewer and the object using the lattice divisional areas.

When an object is included in particular horizontally divisional areas and particular vertically divisional areas, the intersection of the horizontally divisional area and the vertically divisional area may correspond to the lattice. Therefore, to determine an approximate distance from the object, one of the horizontally divisional area and the vertically divisional area may be used. However, to determine an accurate distance from the object, both of the horizontally divisional area and the vertically divisional area or the lattice divisional area may be used.

As a division resolution indicating the number of divisional areas included in the virtual plate increases, the distance from the object may be determined more accurately, but the computation quantity may undesirably increase. Therefore, the manufacture may determine the division resolution in consideration of the computation quantity available from the system.

Referring again to FIG. 2, the area extraction unit 150 may extract the divisional areas corresponding to the object, among the plurality of divisional areas formed by dividing the image 200.

In extracting the divisional areas, the area extraction unit 150 may extract the divisional areas on which the object is overlaid by applying a virtual plate including the plurality of divisional areas to the image 200 or by dividing the image 200 into a plurality of divisional areas and identifying the divisional areas corresponding to the object, among the plurality of divisional areas, on which the target object is located. It may be understood that the employing the virtual plate to the image 200 corresponds to overlaying the virtual plate on the image 200.

The digital image 200 acquired by the camera 110 may include a plurality of objects 211, 212, 213, 220 and 230. Here, a process of selecting a target for determining a distance may further be provided. In addition, a process of determining the kind of an object to select the target may also be provided. However, these processes may deviate from the spirit and scope of the present invention, and detailed descriptions thereof will be omitted. Moreover, in determining the kind of the object and selecting the target object, an area range of the object included in the image 200 may be determined. In other words, a two-dimensional coordinate area of the image may be determined and then transmitted to the area extraction unit 150. The area extraction unit 150 may identify to which one among the divisional areas the received coordinate area belongs.

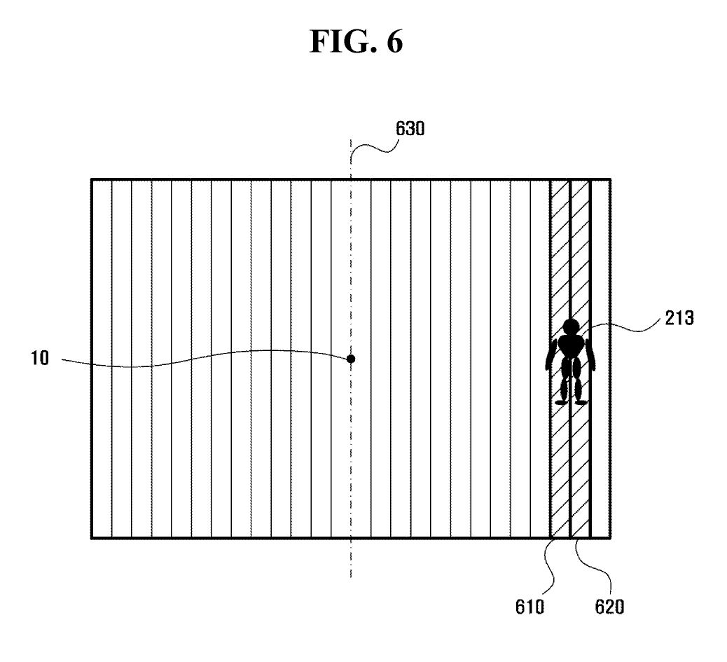

FIG. 6 illustrates an exemplary view of a target object overlaid on a portion of the vertically divisional areas shown in FIG. 4. In FIG. 6, the human 213 positioned at the right end of the image 200, shown in FIG. 2 as a target object, and vertically divisional areas 610 and 620 including the target object 213 are illustrated.

As described above, the horizontal distance may be taken into consideration without considering the vertical distance in determining the distance between each of the vertically divisional areas 610 and 620 and the vanishing point 10. In other words, a distance between an imaginary vertical line 630 including the vanishing point 10 and each of the vertically divisional areas 610 and 620 may be understood as the horizontal distance between each of the vertically divisional areas 610 and 620 and the vanishing point 10.

Moreover, the coordinate area transmitted to the area extraction unit 150 may have a rectangular shape, a circular shape, an elliptical shape or a polygonal shape and the shape of the coordinate area may not be identical with that of the divisional area. Furthermore, the area extraction unit 150 may extract divisional areas to include substantially the entire coordinate area. When a substantially small portion of the coordinate area deviates from the divisional areas, it may not be included in the extracted divisional areas.

Referring to FIG. 6, portions of human arms may deviate from the vertically divisional areas. More specifically, the area extraction unit 150 may extract the vertically divisional areas 610 and 620 such that the body is included in the vertically divisional areas 610 and 620 while portions of arms are not included in the vertically divisional areas 610 and 620.

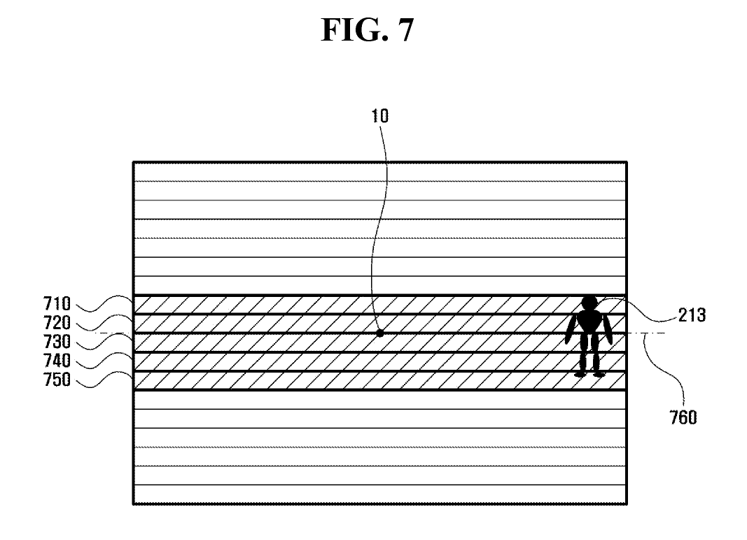

FIG. 7 illustrates an exemplary view of a target object overlaid on a portion of the horizontally divisional areas shown in FIG. 3. In FIG. 7, the human 213 positioned at the right end of the image 200, shown in FIG. 2 as a target object, and horizontally divisional areas 710, 720, 730, 740 and 750 including the target object 213 are illustrated.

As described above, the vertical distance may be taken into consideration without considering the horizontal distance in determining the distance between each of the horizontally divisional areas 710, 720, 730, 740 and 750 and the vanishing point 10. In other words, a distance between an imaginary horizontal line 760 including the vanishing point 10 and each of the horizontally divisional areas 710, 720, 730, 740 and 750 may be understood as the vertical distance between each of the horizontally divisional areas 710, 720, 730, 740 and 750 and the vanishing point 10.

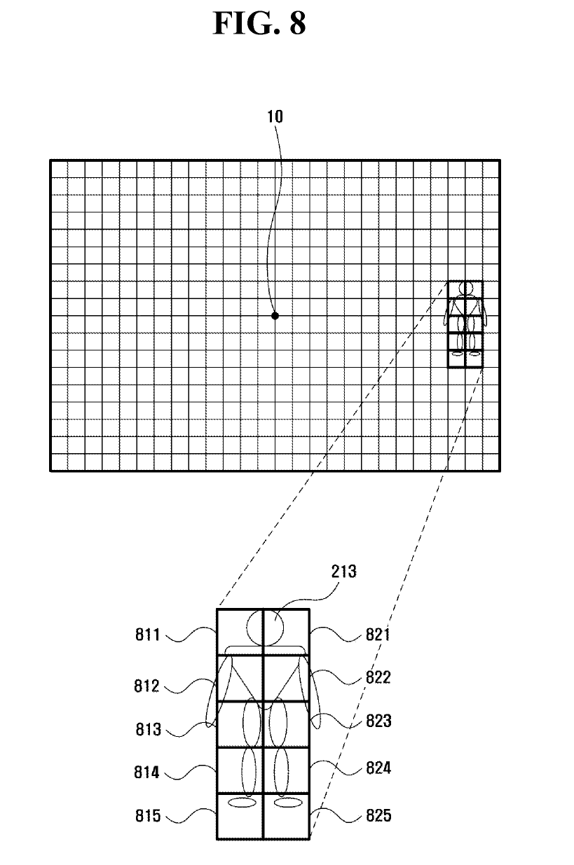

FIG. 8 illustrates an exemplary view of a target object overlaid on a portion of the lattice divisional areas shown in FIG. 5. In FIG. 8, the human 213 positioned at the right end of the image 200, shown in FIG. 2 as a target object, and lattice divisional areas 811, 812, 813, 814, 815, 821, 822, 823, 824 and 825 including the target object 213 are illustrated.

As described above, when an object is included in both of particular horizontally divisional areas and particular vertically divisional areas, intersections of the horizontally divisional areas and the vertically divisional areas may correspond to the lattice divisional areas. The targets of FIGS. 6 to 8 are the same, that is, the object 213 among the objects 211, 212, 213, 220 and 230 shown in FIG. 2. When the vertically divisional areas 610 and 620, shown in FIG. 6, and the horizontally divisional areas 710, 720, 730, 740 and 750 may cross each other, intersection areas thereof may correspond to the lattice divisional areas 811, 812, 813, 814, 815, 821, 822, 823, 824 and 825.

Referring to FIGS. 6 to 8, the area extraction unit 150 shown in FIG. 6 may extract two vertically divisional areas 610 and 620, the area extraction unit 150 shown in FIG. 7 may extract five horizontally divisional areas 710, 720, 730, 740 and 750, and the area extraction unit 150 shown in FIG. 8 may extract ten lattice divisional areas 811, 812, 813, 814, 815, 821, 822, 823, 824 and 825.

The intersection areas of the horizontally divisional areas and the vertically divisional areas may correspond to the lattice divisional areas. However, the number of values extracted from the respective area extraction units shown in FIGS. 6 to 8 may vary according to the area division method employed. More specifically, when employing both of the horizontally divisional areas and the vertically divisional areas, the number of extracted values may be smaller than the number of extracted values when employing the lattice divisional areas. Therefore, the divisional areas may be extracted by selectively using one of the methods of employing both of the horizontally divisional areas and the vertically divisional areas and the method of employing the lattice divisional areas in consideration of the storage capacity limit of the memory 120 temporarily storing data and the computation quantity in processing the values extracted by the area extraction unit 150.

The area division method employed may be selected by the user, and the area extraction unit 150 may extract divisional areas, on which the object is overlaid, using the selected area division method employed.

The output unit 160 may output the divisional areas extracted by the area extraction unit 150. In other words, FIG. 6 shows that two vertically divisional areas may be output, FIG. 7 shows that five horizontally divisional areas may be output and FIG. 8 shows that ten lattice divisional areas may be output. In particular, the divisional areas output from the output unit 160 may be intrinsic information indicating divisional areas, including identifiers or addresses. The output divisional area information may be used by a separate device (not shown) when determining a distance between a viewer and an object.

In addition, determining the distance between a viewer and an object may be provided in the location information providing apparatus 100. The location information generation unit 140 may generate location information of the object using the divisional areas output from the output unit 160. Furthermore, the location information may indicate the distance between the viewer and the object. Specifically, the location information may be understood as a distance between the camera 110 and the object. In addition, the location information may include a horizontal angle of the object with respect to an imaginary reference line formed by aiming the camera 110 toward the object.

As described above, in the present invention, the target object for determining the distance may be a human or an animal, where the animal is limited to a land animal (i.e., a flying animal, such as a bird or an insect is not taken into consideration in the present invention). It may be understood that the object living on land, like the human or land animal, necessarily makes a contact with the ground surface. In addition, the distance between the horizontally divisional area and the object may be determined on which of the horizontally divisional areas a bottom end of the object is located.

For example, when a substantially large object appears and when the horizontally divisional areas including the bottom end of the object are close to the vanishing point 10, the object may be far from the viewer. On the other hand, when a substantially small object appears and when the horizontally divisional areas including the bottom end of the object are far from the vanishing point 10, the object may be close to the viewer. Accordingly, when the extracted divisional area are horizontally divisional areas or lattice divisional areas, the location information generation unit 140 of the present invention may determine a distance from the object by referring to the divisional areas corresponding to the bottom end of the object.

More specifically, the location information generation unit 140 may determine a distance from the object based on an area determined to be substantially close to the ground surface among coordinate areas constituting the object. It may be understood that the bottommost horizontally divisional area 750 shown in FIG. 7 and the bottommost lattice divisional areas 815 and 825 shown in FIG. 8 may be divisional areas taken into consideration when the location information generation unit 140 determines the distance from the object.

The distance from the object may be determined by the location information generation unit 140 taking in consideration the distance between the vanishing point 10 and each of the divisional areas.

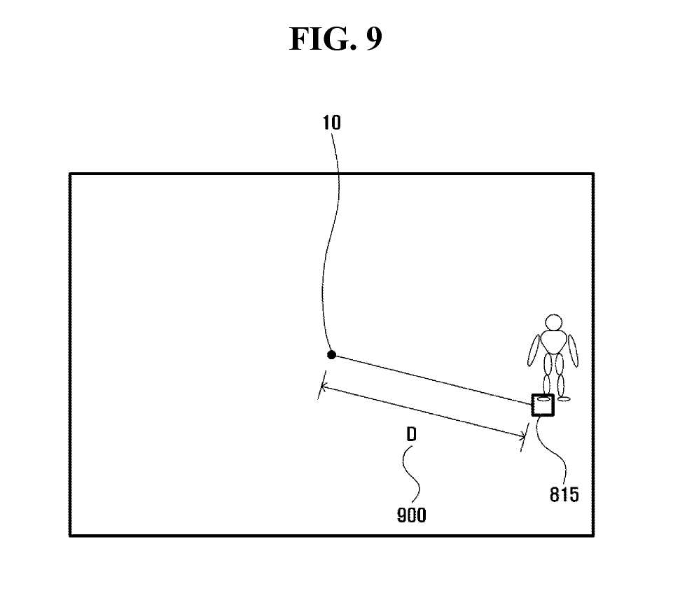

FIG. 9 illustrates an exemplary view of a distance between one of the lattice divisional areas, on which the target object is overlaid in FIG. 8, and the vanishing point 10. In detail, FIG. 9 illustrates the distance 900 between the lattice divisional area 815 positioned in the left bottom end in FIG. 8, among the 10 lattice divisional areas, and the vanishing point 10.

As described above, when the extracted divisional areas are horizontally divisional areas or lattice divisional areas, the bottommost divisional area may be used as a basis for determining the location of the object. When multiple divisional areas are positioned at the bottom end, the location information generation unit 140 may determine the distance from the vanishing point 10 based on the divisional area that is substantially close to the vanishing point 10. In addition, when multiple divisional areas are positioned at the bottom end, the location information generation unit 140 may determine the distance between a middle portion of the multiple divisional areas and the vanishing point 10 based on the divisional area substantially far from the vanishing point 10.

Moreover, the location information generation unit 140 may generate location information of the object based on the distance between the vanishing point 10 and each of the divisional areas. Alternatively, the location information of the object may be extracted using a mapping table (not shown) stored in the memory 120. In other words, the memory 120 may store horizontal angles and distances mapped for each divisional area or combinations of divisional areas. For example, the horizontal angle and the distance may be applied to a pair of a horizontally divisional area and a vertically divisional area may be stored in the memory 120, or the horizontal angle and distance may be mapped to each of the lattice divisional areas, which will now be described with reference to FIGS. 6 and 7.

When the vertically divisional areas 610 and 620 and the horizontally divisional areas 710, 720, 730, 740 and 750 are received from the area extraction unit 150, the location information generation unit 140 may extract the vertically divisional area 610 of the vertically divisional areas 610 and 620, which may be substantially close to the vanishing point 10, and the bottommost horizontally divisional area 750 among the horizontally divisional areas 710, 720, 730, 740 and 750. In addition, the location information generation unit 140 may apply the extracted vertically divisional areas 610 and the extracted horizontally divisional area 750 to the mapping table. Thus, since the horizontal angle and distance corresponding to the pair of the horizontally divisional area and the vertically divisional areas may be unique, the location information generation unit 140 may generate the unique values for the horizontal angle and distance as the location information.

The memory 120 may be a module capable of inputting and outputting information, including a hard disk, a flash memory, a compact flash (CF) card, a secure digital (SD) card, a smart media (SM) card, a multimedia card (MMC), or a memory stick, and may be provided within the location information providing apparatus 100 or in a separate system.

Meanwhile, it may be difficult to determine an accurate distance from the object using merely the distance between the vanishing point 10 and each of the divisional areas. Specifically, when the object is overlaid on the divisional areas close to the vanishing point 10, a mere slight difference in the location may produce a considerable difference in actual locations. Thus, to overcome this problem, the division resolution may be increased. However, the increased division resolution may increase the computation quantity.

Therefore, according to the embodiments of the present invention, as shown in FIGS. 3 to 8, sizes of the divisional areas may be the same, irrespective of the distance from one or more particular points included in the virtual plate or the image, that is, the distance from the vanishing point 10. Alternatively, sizes of the divisional areas may differ from each other according to the distance from the vanishing point 10.

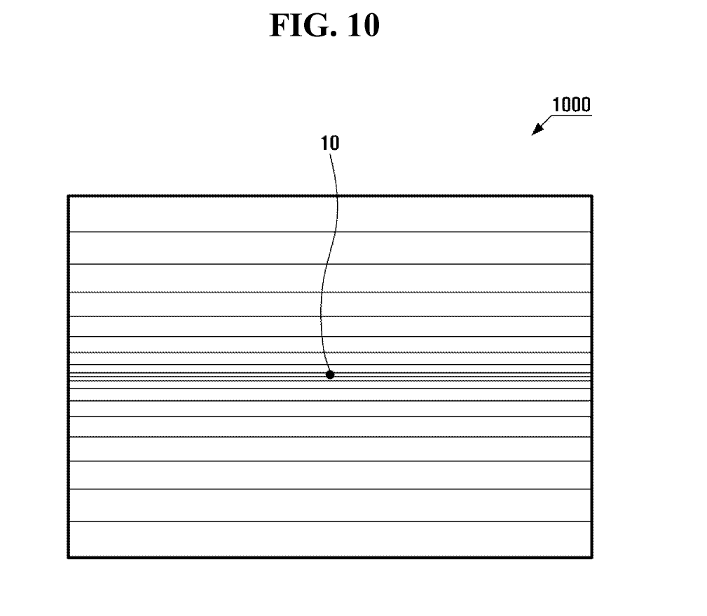

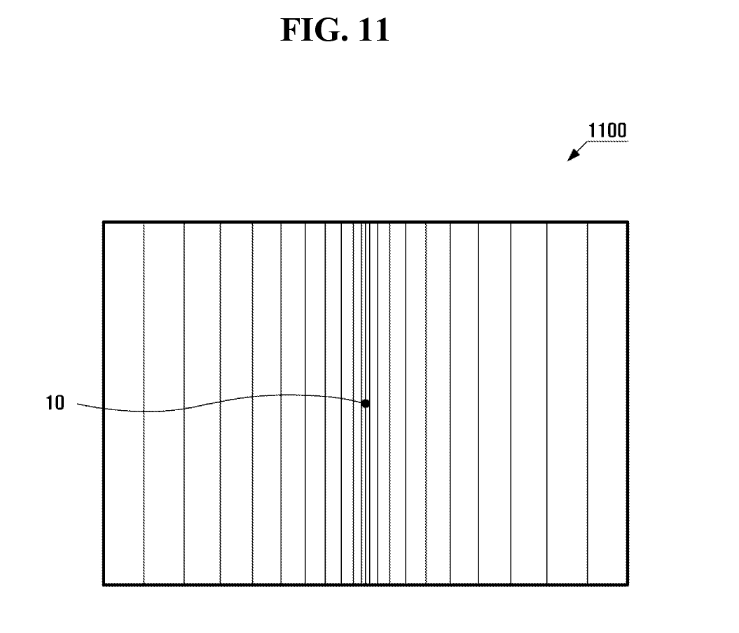

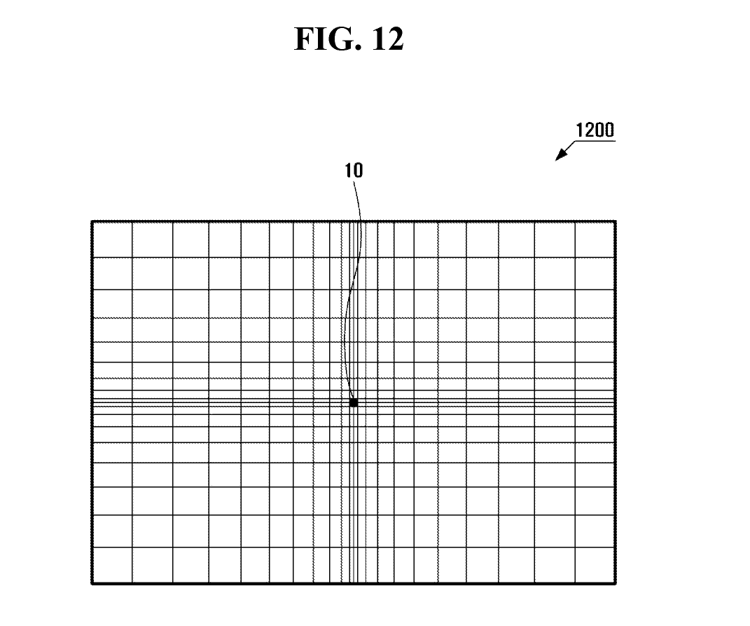

FIGS. 10 to 12 illustrate exemplary views of sizes of divisional areas varying according to the distance from the vanishing point 10. Specifically, FIG. 10 illustrates a virtual plate 1000 having horizontally divisional areas, FIG. 11 illustrates a virtual plate 1100 having vertically divisional areas, and FIG. 12 illustrates a virtual plate 1200 having lattice divisional areas.

As described above, the divisional areas may be formed as different sizes according to the distance from the vanishing point 10, thereby determining a more accurate distance from the object without increasing the division resolution.

While FIGS. 10 to 12 illustrate that one vanishing point exists at the center of the virtual plates 1000, 1100 and 1200, the present invention is not limited thereto. A plurality of vanishing points may be included in the virtual plates and the divisional areas may have different patterns accordingly. For example, when vanishing points (not shown) exist at opposite ends of a horizontal line passing the center of the virtual plate and the extracted divisional areas are vertically divisional areas, the vertically divisional areas close to the both vanishing points may be formed in substantially small sizes. Meanwhile, since the vertically divisional areas existing at the center of the virtual plates may be far from the vanishing points, they may be formed in substantially large sizes.

To determine patterns of divisional areas, it may be important to identify locations of vanishing points in advance. The locations of vanishing points may be identified by analyzing the shapes of objects included in an image and the relationship between the objects, which, however, departs from the spirit and scope of the present invention and a detailed description thereof will be omitted.

While the present invention has been particularly shown and described with reference to exemplary embodiments thereof, it will be understood by those of ordinary skill in the art that various modifications, additions and substitutions are possible without departing from the spirit and scope of the present invention as disclosed in the accompanying claims. It is therefore desired that the present embodiments be considered in all respects as illustrative and not restrictive, reference being made to the accompanying claims rather than the foregoing description to indicate the scope of the invention.

What is claimed is:

1. An apparatus for providing location information, the apparatus comprising:
a camera configured to generate an image including a photographed object; and
a processor configured to:
extract divisional areas corresponding to the photographed object, among a plurality of divisional areas formed by dividing the image; and
output the extracted divisional areas.

2. The apparatus of claim 1, wherein the processor is further configured to extract the divisional areas on which the photographed object is overlaid by applying a virtual plate including a plurality of areas to the image.

3. The apparatus of claim 2, wherein the divisional areas are selected from at least one of a group consisting of: horizontally divisional areas formed by dividing the virtual plate in a horizontal direction, vertically divisional areas formed by dividing the virtual plate in a vertical direction, and lattice divisional areas formed by dividing the virtual plate in horizontal and vertical directions.

4. The apparatus of claim 3, wherein sizes of the divisional areas are the same or vary according to the distance from one or more particular points included in the virtual plate.

5. The apparatus of claim 3, wherein the processor is further configured to generate the location information of the photographed object by referring to the extracted divisional areas,
wherein the location information of the photographed object includes at least one of a horizontal angle of the photographed object with respect to an imaginary reference line formed by aiming the camera unit, and a distance from the photographed object.

6. The apparatus of claim 5, wherein when the extracted divisional areas are horizontally divisional areas or lattice divisional areas, the processor is configured to determine the distance from the photographed object by referring to the divisional areas corresponding to a bottom end of the photographed object.

7. The apparatus of claim 1, wherein the processor is further configured to extract divisional areas corresponding to the photographed object by dividing the image into the plurality of divisional areas,
wherein the divisional areas are selecting from at least one of a group consisting of: horizontally divisional areas formed by dividing the image in a horizontal direction, vertically divisional areas formed by dividing the image in a vertical direction, and lattice divisional areas formed by dividing the image in horizontal and vertical directions.

8. The apparatus of claim 7, wherein sizes of the divisional areas are the same or vary according to the distance from one or more particular points included in the image.

9. The apparatus of claim 7, wherein the processor is further configured to generate the location information of the photographed object by referring to the extracted divisional areas,
wherein the location information of the photographed object is selected from a at least one of a group consisting of: a horizontal angle of the photographed object with respect to an imaginary reference line formed by aiming the camera toward the photographed object, and a distance from the photographed object.

10. The apparatus of claim 9, wherein when the extracted divisional areas are horizontally divisional areas or lattice divisional areas, the processor is further configured to determine the distance from the photographed object by referring to the divisional areas corresponding to a bottom end of the photographed object.

11. A method for providing location information, the method comprising:
generating an image including a photographed object using a camera;
extracting, by a processor, divisional areas corresponding to the photographed object, among a plurality of divisional areas formed by dividing the image; and
outputting, by the processor, the extracted divisional areas.

12. The method of claim 11, the extracting of the divisional areas further comprising extracting, by the processor, the divisional areas on which the photographed object is overlaid by applying a virtual plate including a plurality of areas to the image,
wherein the divisional areas are selected from at least one of a group consisting of: horizontally divisional areas formed by dividing the virtual plate in a horizontal direction, vertically divisional areas formed by dividing the virtual plate in a vertical direction, and lattice divisional areas formed by dividing the virtual plate in horizontal and vertical directions.

13. The method of claim 12, wherein sizes of the divisional areas are the same or vary according to the distance from one or more particular points included in the virtual plate.

14. The method of claim 12, further comprising generating, by the processor, the location information of the photographed object by referring to the extracted divisional areas,
wherein the location information of the photographed object is selected from at least one of a group consisting of: a horizontal angle of the photographed object with respect to an imaginary reference line formed by aiming the camera toward the photographed object, and a distance from the photographed object.

15. The method of claim 14, wherein when the extracted divisional areas are horizontally divisional areas or lattice divisional areas, the generating of the location information, by the processor, further comprises determining the distance from the photographed object by referring to the divisional areas corresponding to a bottom end of the photographed object.

16. The method of claim 11, wherein the extracting, by the processor, of the divisional areas further comprises extracting the divisional areas corresponding to the photographed object by dividing the image into the plurality of divisional areas,
wherein the divisional areas are selected from at least one of a group consisting of: horizontally divisional areas formed by dividing the image in a horizontal direction, vertically divisional areas formed by dividing the image in a vertical direction, and lattice divisional areas formed by dividing the image in horizontal and vertical directions.

17. The method of claim 16, wherein sizes of the divisional areas are the same or vary according to the distance from one or more particular points included in the image.

18. The method of claim 16, further comprising generating, by the processor, the location information of the photographed object by referring to the extracted divisional areas,
wherein the location information of the photographed object is selected from at least one of a group consisting of: a horizontal angle of the photographed object with respect to an imaginary reference line formed by aiming the camera toward the photographed object, and a distance from the photographed object.

19. The method of claim 18, wherein when the extracted divisional areas are horizontally divisional areas or lattice divisional areas, the generating of the location information, by the processor, further comprises determining the distance from the photographed object by referring to the divisional areas corresponding to a bottom end of the photographed object.

20. A non-transitory computer readable medium containing program instructions executed by a processor, the computer readable medium comprising:
program instructions extracting divisional areas corresponding to a photographed object in an image generated by a camera in communication with the processor, among a plurality of divisional areas formed by dividing the image; and
program instructions outputting the extracted divisional areas.

21. The non-transitory computer readable medium of claim 20, further comprising program instructions extracting the divisional areas on which the photographed object is overlaid by applying a virtual plate including a plurality of areas to the image,
wherein the divisional areas are selected from at least one of a group consisting of: horizontally divisional areas formed by dividing the virtual plate in a horizontal direction, vertically divisional areas formed by dividing the virtual plate in a vertical direction, and lattice divisional areas formed by dividing the virtual plate in horizontal and vertical directions.

22. The non-transitory computer readable medium of claim 20, further comprising:
program instructions generating the location information of the photographed object by referring to the extracted divisional areas,
wherein the location information of the photographed object is selected from at least one of a group consisting of: a horizontal angle of the photographed object with respect to an imaginary reference line formed by aiming the camera toward the photographed object, and a distance from the photographed object; and
program instructions determining the distance from the photographed object by referring to the divisional areas corresponding to a bottom end of the photographed object when the extracted divisional areas are horizontally divisional areas or lattice divisional areas, the generating of the location information further comprises.

23. The non-transitory computer readable medium of claim 20, further comprising program instructions extracting the divisional areas corresponding to the photographed object by dividing the image into the plurality of divisional areas,
wherein the divisional areas are selected from at least one of a group consisting of: horizontally divisional areas formed by dividing the image in a horizontal direction, vertically divisional areas formed by dividing the image in a vertical direction, and lattice divisional areas formed by dividing the image in horizontal and vertical directions.

24. The non-transitory computer readable medium of claim 20, further comprising:
program instructions generating the location information of the photographed object by referring to the extracted divisional areas,
wherein the location information of the photographed object is selected from at least one of a group consisting of: a horizontal angle of the photographed object with respect to an imaginary reference line formed by aiming the camera toward the photographed object, and a distance from the photographed object; and
program instructions generating of the location information further comprise determining the distance from the photographed object by referring to the divisional areas corresponding to a bottom end of the photographed object when the extracted divisional areas are horizontally divisional areas or lattice divisional areas.
